(19) United States
(12) Patent Application Publication
(10) Pub. No.: US 2006/0216455 A1
(43) Pub. Date: Sep. 28, 2006

(54) Fabric backed roll-up sign material and garment tapes

(76) Inventors: Jay Soaft, New Britain, CT (US); Brook M. Jerzyk, Madison, CT (US); Jeff S. Staniunas, Manchester, CT (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/343,750

(22) Filed: Jan. 30, 2006

Related U.S. Application Data
(60) Provisional application No. 60/648,613, filed on Jan. 31, 2005.

(51) Int. Cl. B32B 3/00; B29C 33/40; B32B 5/16; G11B 9/00; B32B 17/10; B32B 7/12; A47G 35/00

(52) U.S. Cl. 428/60; 264/220; 428/161; 428/323; 428/331; 428/338; 428/339; 428/343; 428/352; 428/354; 428/542.6

(57) ABSTRACT

A retroreflective sheeting includes a base layer that includes a thermoplastic polymer. A prism layer is positioned on the base layer. A fabric layer has a thermoplastic coating on a side of the fabric layer, wherein the thermoplastic coating faces the prism layer and wherein portions of the base layer, prism layer, thermoplastic coating, and fabric layer are attached to form a seal. A method for forming a retroreflective sheeting includes providing a base layer that includes a thermoplastic polymer with a prism layer positioned on the layer. A fabric layer having a thermoplastic coating on a side of the fabric layer is positioned with the thermoplastic coating facing the prism layer. A die is applied against the base layer and fabric layer in the presence of sufficient heat to cause the thermoplastic coating on the fabric and the base layer to attach portions of the base layer to the thermoplastic coating on the fabric layer, thereby forming a retroreflective structure.

### RELATED APPLICATION

This application claims the benefit of U.S. Provisional Application Ser. No. 60/648,613, filed Jan. 31, 2005. The entire teachings of the above application are incorporated herein by reference.

### BACKGROUND OF THE INVENTION

Retroreflective signs have many uses, including traffic safety signs. Often these signs are only needed for use on a temporary basis, such as a warning sign for road work ahead or that a car has broken down by the side of the road. Before and after use of these signs, they may need to be stored in as compact space as possible. This typically requires that the signs be rolled up or folded.

One of the difficulties with known retroreflective signs is that they have a plastic sheeting for a backing. Although plastic sheeting can be flexible and can be rolled up, the sheeting can still be relatively stiff.

Therefore, a need exits for a retroreflective structure that is more flexible and that can be more tightly rolled.

### SUMMARY OF THE INVENTION

A retroreflective sheeting includes a base layer that includes a thermoplastic polymer and a fabric layer. A prism layer is positioned on the base layer. The fabric layer has a thermoplastic coating on one side thereof. The fabric layer is postioned such that the thermoplastic coating faces the prism layer. Portions of the base layer, prism layer has a thermoplastic coating on one side thereof. The fabric layer is postioned such that the thermoplastic coating faces the prism layer. Portions of the base layer, prism layer, thermoplastic coating, and fabric layer are attached to at least one of each other to form a seal.

In one embodiment, the thermoplastic coating includes thermoplastic polyurethane.

In another embodiment, the thermoplastic coating includes polyvinyl chloride.

A method for forming a retroreflective sheeting includes providing a base layer that includes a thermoplastic polymer with a prism layer positioned thereon. A fabric layer having a thermoplastic coating on a side of the fabric layer is positioned with the thermoplastic coating facing the prism layer. A die is applied against the base layer and fabric layer in the presence of sufficient heat to cause the thermoplastic coating on the fabric and the base layer to attach portions of the base layer to the thermoplastic coating on the fabric layer, thereby forming a retroreflective structure. The thermoplastic coating can include a thermoplastic polyurethane or polyvinyl chloride.

An advantage of the present invention is that by employing the fabric as a backing material, a more flexibile retroreflective structure is provided than if one only used a plastic sheeting for a backing.

The retroreflective sheeting structures according to the present invention can be used in roll-up traffic and road signs, or even as garment tapes.

### BRIEF DESCRIPTION OF THE DRAWINGS

FIG. 1 is a cross-sectional view of an embodiment of a retroreflective structure of the present invention prior to welding.

FIG. 2 is a cross-sectional view of an embodiment of a retroreflective structure of the present invention after welding.

FIG. 3 is a partial top view of a first embodiment of the retroreflective structure of the present invention after welding.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

A description of preferred embodiments of the invention follows.

The features and other details of the method and apparatus of the invention will now be more particularly described with reference to the accompanying drawings and pointed out in the claims. The same numeral present in different figures represents the same item. It will be understood that the particular embodiments of the invention are shown by way of illustration and not as limitations of the invention. The principal features of this invention can be employed in various embodiments without departing from the scope of the invention.

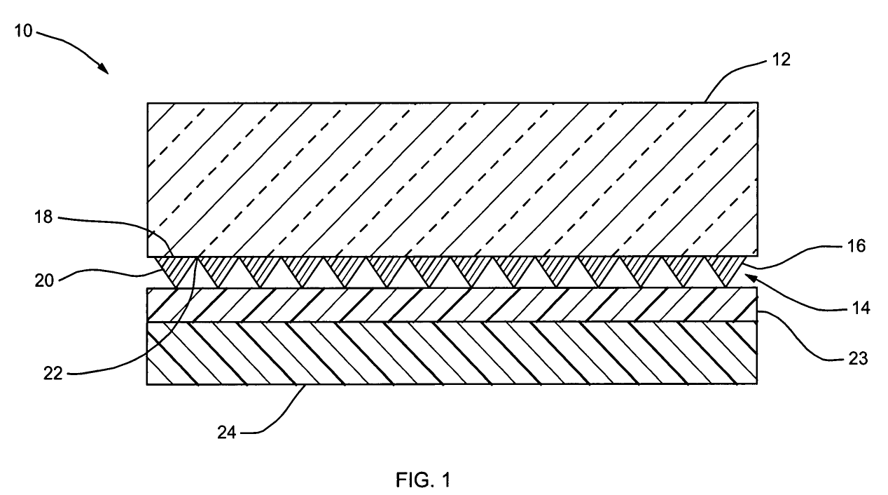

Retroreflective structure 10, as shown in FIG. 1, has a base film 12 that is comprised of a transparent thermoplastic film, The base film 12 may be formed of polyvinyl chloride, polyvinylidene chloride, urethane films, polyfluorocarbon polymers, etc., or other thermoplastic which has a relatively low temperature of distortion. In one embodiment, such a low temperature of distortion is in the range of between about 180° F. (82° C.) and 200° F. (93° C.). The distortion temperature is the temperature at which a polymer melts and begins to flow. In another embodiment, the thermoplastic is an ethylene-tetrafluoroethylene copolymer.

Base film 12 can be transparent to visible light and can be either clear or colored.

Base film 12 can have a thickness in the range of between about 0.003 and 0.02 inches (0.0076 and 0.051 cm). In one embodiment, the thickness is about 10 mils (0.0254 cm) for a polyvinyl chloride sheeting. The selected thickness depends upon the method of fabrication, such as radio high frequency welding or ultrasonic welding, the thermoplastic selected, and the characteristics desired for the retroreflective structure. Examples of suitable methods for sealing are found in U.S. Pat. Nos. 6,039,909, 6,143,224, and 6,231,797, the teachings of which are incorporated by reference.

A prism array 14, which can include retroreflective cube-corner prism elements 16, is formed on the base film 12. Prism array 14 has a window side 18 and facet sides 20. The window side 18 is the side attached to the base film 12.

Prism array 14 is formed of a transparent polymer. The prism polymers can have a higher distortion temperature than that of the base film. Alternatively, prism polymers and base film can have a similar distortion temperature. For example, in one embodiment, the temperature of distortion of the polymer of prism array 14 can be about 350° F. (177° C.).

After being formed, the polymer is substantially rigid at room temperature, which is defined as being substantially inflexible. This rigidity of the polymer in the prism array allows the prism elements to retain their optical characteristics. The prism array polymer can also be nonextensible, which is defined as not being capable of being substantially stretched without breaking.

The polymer used for prism array 14 is selected from a wide variety of polymers which include the polymers of urethane, acrylic acid esters, cellulose esters, ethylenically unsaturated nitrites, polyacrylates including but not limited to reaction products of urethane acrylates, polyester acrylates, and epoxy acrylates, hard epoxy acrylates, etc. Other polymers include polycarbonates, polyesters and polyolefins, acrylated silanes, hard polyester urethane acrylates. Preferably, the polymer can be cast in a prismatic mold with a monomer or oligomer polymerization initiated by ultraviolet radiation. Alternatively, polymers with a low distortion temperature can be used. These polymers include polyvinyl chloride, vinylidene chloride, and other vinyl halides.

The individual prism elements 16 of the prism array 14 can be cube-corner in shape and have a pitch in the range of between about 0.003 and 0.02 inches (0.0076 and 0.051 cm). In one embodiment, the pitch has a distance of about 0.006 inches (0.015 cm). Preferably, each pitch has a distance of between about 0.004 and 0.008 inches (0.01 and 0.02 cm).

The thickness of prism array 14 at valley 22, where the rigid prism elements 16 intersect, is sufficiently thin so that the prism array 14 can crack and split along the valleys 22 when a minimal force is applied. In one embodiment, the thickness of prism array 14 is in the range of between about 0.0028 and 0.009 inches (0.007 and 0.023 cm).

The base film 12 provides a substrate for prism array 14--specifically, it provides a smooth surface upon which the prism elements 16 can attach, preferably to the window side 18 of the prism elements 16. The prism array 14 can be laminated to the base film 12 with a transparent adhesive. Alternatively, the prism array 14 can be cast directly onto the base film 12.

Alternatively, base film 12 and prism array 14 can be formed of the same materials. When heated, the base layer and prism can melt and flow together.

Backing 24 is placed on the facet side 20 of the prism array 14. The backing 24 is formed as a fabric layer with a thermoplastic coating 23 on the side that faces the prism array 14. The fabric can be nylon which has a higher distortion or melt temperature than the base layer. In other embodiments, the fabric backing 24 includes woven polyester or micronized polyester. The fabrics chosen for backing can include a range of thread sizes. For example, the thread sizes can be in the range of between about 70 and about 210 deniers. Examples of suitable nylon fabrics are available from DAF Products, Inc. of Wycoff, N.J. The fabric can be of any width, such as 36 or 48 inches (91.44 or 121.94 cm). Other suitable fabrics are available from Amerbelle Textiles of Vernon, Conn. The fabric has been found to provide greater flexibility to the retroreflective structure than one formed with a plastic sheeting.

The fabric backing 24 includes sufficient thermoplastic coating 23 on one side to allow the fabric backing 24, the prism array 14, and the base film 12 to be joined together with a coating. A suitable thermoplastic coating 23 is one that softens at about a similar temperature as the base film, thereby allowing the coating and base film 12 to flow together and form a bond. For example, the thermoplastic coating 23 is radio frequency weldable. Examples of a suitable thermoplastic coating 23 can include thermoplastic polyurethane and polyvinyl chloride. An example of a thermoplastic polyurethane coating is product 7558210 DTPU 75 available from DAF Products, Inc. Other suitable thermoplastic polyurethanes are available from Amerbelle of Windsor, Conn. Such a thermoplastic has a low melt temperature, which can be in the range of between about 180° F. (82° C.) and 200° F. (93° C.).

The prism array 14 appears to act as barrier to the welding of the first layer, base film 12, to the coating layer 23 on fabric 24. An effective way to weld and form the sheeting is to move the prisms out of the way, to allow the thermoplastic in the base film 12 and the backing film 24 to form a bond. The pyramidal shape of the prisms promotes instability and if the base film 12 can be softened, the prisms can move or tumble out of the way. If the prism array 14 is formed of a low distortion temperature material, the prisms array 14 can easily melt and meld together with the base layer 12 and thermoplastic coating 23.

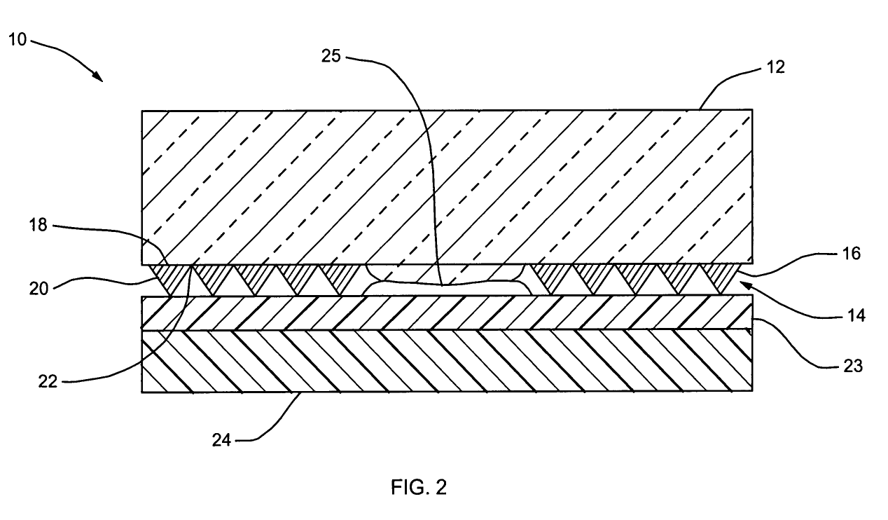

High frequency welding is the joining of two thermoplastic surfaces by melting under heat and pressure, which is brought about by molecular friction. Molecules within the material are subject to internal stresses caused by an electrical field alternating in polarity several million times per second. When the heat exceeds the melting point (distortion temperature) of the base film 12 under pressure, the two surfaces collapse and meld, thus forming a joint. FIG. 2 is a cross-sectional view of an embodiment of a retroreflective structure after welding with weld 25.

The welding can be performed by the use of radio frequency or dielectric sealing equipment. Suitable welding equipment includes equipment sold under the tradenames, Thermatron, Kosmos, Kiefel and Callanan. The equipment operates on the principle of a generator oscillating at a radio frequency of about 27.12 MHz. The press has an upper platen and a lower platen. A die can be located on the upper platen or the lower platen. In the raised or up position, the base film 12 with prism array and the backing film are laid between the patterns. The die which is either located on the upper platen or the lower platen has a seal pattern. Upon closure of the press, high frequency radio energy is applied, causing the polar molecules in the base film 12 and the thermoplastic coating of backing film to become agitated and heated to their temperature of distortion and melting point.

The die, which is pressed against the base film and fabric, contains lands and edges. The prism elements move and allow the base film and fabric to meet and thus meld or join together. The amount of this welding is controlled by time, temperature and radio frequency power level. For example, in forming a polymer chloride sheeting with polyacrylate prisms and a thermoplastic coating on fabric at a rate of six feet (1.83 cm) per second, platen pressure can be about 413.7 kPa (60 psi) and a platen temperature of about 90° F. (32° C.). The radio energy can be about 30 kwatts. The platen current can be about 3.5 DC amps, and a grid current can be about 0.08 DC amps.

Pressure can be applied by the heated platens for a preseal step of about two seconds prior to exposure to the radio frequency, then for a sealing step of about 3.3 seconds while the sheeting and prisms are exposed to the radio energy and then for a cooling step after exposure to the radio energy for about one second.

In one embodiment, the die employed is brass. Lands can be a center bevel or flat rule with a width range of 0.013 inches (0.0325 cm) to 0.030 inches (0.075 cm). The die can also be formed of magnesium, etched steel, copper or any other suitable die making material known in the art. For a magnesium die, the inner seal widths are referred to as 9 point line weight (0.013 inches, 0.033 cm), which is an indication of is their etched width. However, the line weights can range from about 0.1 to 3.0 points, which is about 0.001 to 0.042 inches (0.0025 to 0.107 cm).

Other dies employed to make an embodiment have an outer tear seal, which is a sharp edge, of about 0.001 to 0.042 inches (0.0025 to 0.107 cm). This allows the formed retroreflective structure to be removed from the skeleton, or waste from a non-fabric polyvinyl chloride substrate around the perimeter of the retroreflective structure.

When inner seals are used then the lands are machined down about 0.014 inches (0.036 cm) below the height of the tear seal in order not to tear the inner cells. In the case of a brass die, the inner seals are kept to a height of about 0.008 inches (0.02 cm) below the surface of a tear seal.

The brass die can either be machined from a solid piece of brass or constructed from pieces of brass rule.

The inner seal on the die can form a plurality of cells 36 with a multi-course, hatched pattern perimeter, which when applied to the base film 12 (first), the prism array 14, and the backing film 24 (coated fabric layer) cause a portion of the prism array 14 to dislocate, or melt, thereby allowing the base layer to bond to the coating. The perimeters of the cells 36 can be formed of multiple courses with hatches.

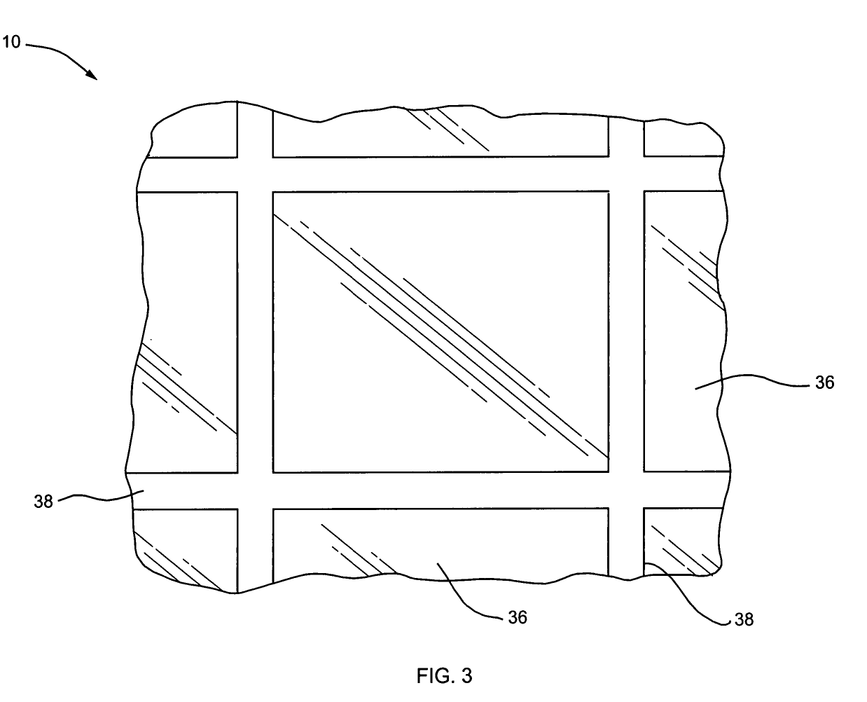

A product, such as a tape, can also be made by forming an edge that is generally sealed on both sides having a width of about 0.25 inches (0.64 cm). This seal is made in a certain pattern. The seal pattern can be a solid, a brick type having several layers wide along the edges, squares, diamonds, triangles, etc. In one embodiment, the pattern is a plurality of offset rows of rectangles (a brick pattern), wherein the rectangles are about 0.0625 by 0.125 inches (0.16 by 0.32 cm). The lands of the die can be flat thus forming a uniform indentation for each rectangle. Alternatively, as shown in FIG. 3, the cells can be formed with a solid perimeter 38.

The pattern provides strength to the sealed product, which is an air-backed retroreflective product. It also provides a pocket in each cell 36, so that if one section of a product should fail by tearing, ripping or leaking, the remainder of the retroreflective structure is still operating both cosmetically and reflectively.

Energy can be also supplied by ultrasonic energy, infrared energy or induction heating for joining the layers. Suitable ultrasonic welding equipment includes equipment sold under the trade names of Branson and Dukane. In a continuous web process, the base film 12, prism array 14 and a backing film 24 are brought together into a rotating die which has inner seals and a pattern. The tape then proceeds to a second station, where the edges are sealed together with a rotating wheel cutter. If the wheel cutter is not rotating, the material does not seal nor can the inner seals and the edge seals be put onto the tape at the same station. Ultrasonic plunge sealers have also been used to seal the edges of a previously radio frequency sealed product, allowing a cone or ring to be welded together. For instance, the ultrasonic frequency can be twenty kHz at a power level of about one to two kilowatts. The retroreflective sheeting can be formed at a rate of 5 to 20 feet (1.5 to 6.1 meters) per minute.

Care should be taken to insure that the base film 12, prism array 14 and backing film 24 interface is at the midpoint of the upper and lower platens in order to optimize the heat generated by the high frequency energy.

Normal seal dwell times and dielectric settings should be used as a base line to begin process optimization. Clamping pressures should be the same than those used in traditional high frequency welding. High frequency welding machines vary in regard to power output and pressure from manufacturer to manufacturer and even between machines of the same model. As a rule, it is prudent to evaluate the performance of each machine for different dies and backings as settings may vary from machine to machine.

Too much clamp pressure or an uneven platen or die or both can result in oversealing. Oversealing can weaken the material around the weld and can cause an uneven surface making printing difficult. Sealing through the backing can result in a slightly uneven front surface. If the depth of seal is not too great, if too little pressure is applied, and this results in a poor or no weld at all.

The platen and dies should be as level as possible in order to weld prism sheeting. This is especially true when bar sealing. Down stops should be employed to prevent the die from pushing too far into the substrates.

Weld strength can be tested by the following methods: Cutting into the material and pulling the two substrates apart. The weld is adequate for most applications if either of the films tear before the weld. In general, the most reliable test is to cut into a sample of the material and attempt to separate the substrates. If the sealing equipment is properly calibrated, the dies and platens are leveled and the platen temperatures and dielectric settings are maintained, only periodic testing should be needed to verify the weld performance.

### EQUIVALENTS

While this invention has been particularly shown and described with reference to a preferred embodiments thereof, it will be understood by those skilled in the art that various changes in form and details may be made therein without departing from the scope of the invention encompassed by the appended claims.

What is claimed is:

1. A retroreflective sheeting comprising,
a) a base layer that includes a thermoplastic polymer;
b) a prism layer positioned on said base layer;
c) a fabric layer having a thermoplastic coating on a side of said fabric layer, wherein said thermoplastic coating faces said prism layer and wherein portions of said base layer, prism layer, thermoplastic coating, and fabric layer are attached to form a seal.

2. The retroreflective structure of claim 1 wherein said thermoplastic coating includes a thermoplastic polyurethane.

3. The retroreflective structure of claim 1 wherein said thermoplastic coating includes a polyvinyl chloride.

4. The retroreflective structure of claim 1 wherein said fabric layer includes a fabric selected from the group consisting of nylon and polyester.

5. The retroreflective structure of claim 1 wherein said thermoplastic polymer includes polyvinyl chloride.

6. The retroreflective structure of claim 1 wherein said prism layer includes a polyacrylate.

7. The retroreflective structure of claim 1 wherein said prism layer includes a polyvinyl chloride.

8. The retroreflective structure of claim 1 wherein said prism layer and said base layer are formed of the same material.

9. The retroreflective structure of claim 1 wherein said thermoplastic coating on said fabric includes a thickness of about 0.8 mils.

10. The retroreflective structure of claim 1 wherein said thermoplastic coating includes a polyurethane having a melt temperature in the range of between about 180° F. and 200° F.

11. The retroreflective structure of claim 1 wherein said thermoplastic polymer includes a polymer with a melt temperature in the range of between about 180° F. and 200° F.

12. The retroreflective structure of claim 1 wherein said fabric layer includes thread having a size in the range of 70 and 210 deniers.

13. The retroreflective structure of claim 1 wherein said prism layer includes cube-corner prisms.

14. A method for forming a retroreflective sheeting comprising:
a) providing a base layer that includes a thermoplastic polymer with a prism layer positioned on said layer;
b) positioning a fabric layer having a thermoplastic coating on a side of said fabric layer with said thermoplastic coating facing said prism layer;
c) applying a die against said base layer and fabric layer in the presence of sufficient heat to cause the thermoplastic coating on the fabric and the base layer to attach portions of the base layer to said thermoplastic coating on said fabric layer, thereby forming a retroreflective structure.

15. The method of claim 14 wherein said thermoplastic coating includes a thermoplastic polyurethane.

16. The method of claim 14 wherein said thermoplastic coating includes polyvinyl chloride.

17. The method of claim 14 wherein said fabric layer includes a fabric selected from the group consisting of nylon and polyester.

18. The method of claim 14 wherein said thermoplastic polymer includes polyvinyl chloride.

19. The method of claim 14 wherein said base layer and thermoplastic coating are heated to a temperature in the range of between about 180° F. and 200° F.

20. The method of claim 14 wherein the heat is provided by radio frequency heating.

21. The method of claim 14 wherein said prism layer includes a polyacrylate.

22. The method of claim 14 wherein said prism layer includes a polyvinyl chloride.

23. The method of claim 14 wherein said prism layer and said base layer are formed of the same material.

24. The method of claim 14 wherein said thermoplastic coating on said fabric includes a thickness of about 0.8 mils.

25. The method of claim 14 wherein said thermoplastic coating includes a polyurethane having a melt temperature in the range of between about 180° F. and 200° F.

26. The method of claim 14 wherein said thermoplastic polymer, includes a polymer with a melt temperature in the range of between about 180° F. and 200° F.

27. The method of claim 14 wherein said fabric layer includes thread having a size in the range of 70 and 210 deniers.

28. The method of claim 14 wherein said prism layer includes cube-corner prisms.

29. A sign formed with a retroreflective sheeting of claim 1.
